(19) United States
(12) Patent Application Publication
(10) Pub. No.: US 2020/0049151 A1
(43) Pub. Date: Feb. 13, 2020

(54) LIQUID PUMP

(71) Applicant: Hanon Systems, Daejeon (KR)

(72) Inventors: Ho Sung KANG, Daejeon (KR); Gwang Ok KO, Daejeon (KR); Hyuk KIM, Daejeon (KR); Ok Ryul MIN, Daejeon (KR); Sang Hyun LEE, Daejeon (KR); Jong Du LEE, Daejeon (KR)

(21) Appl. No.: 16/531,353

(22) Filed: Aug. 5, 2019

(30) Foreign Application Priority Data
Aug. 7, 2018 (KR) 10-2018-0091628
Mar. 27, 2019 (KR) 10-2019-0034748

(51) Int. Cl. F04D 15/00; B60H 1/00

(52) U.S. Cl. CPC F04D 15/00; B60H 2001/00307; B60H 1/00278

(57) ABSTRACT

Provided is a liquid pump included in a module in which a flow path is changed depending on an operation mode. The liquid pump may have a flow path change means and a liquid transfer means integrally formed with each other; may reduce a package size by forming an inner flow path which may change a flow of cooling water in the flow path change means and the liquid transfer means which are integrally formed with each other; may have a simplified assembling structure and a coupling structure preventing both cooling water leakage and assembly loosening; and may minimize the number of components, assembling tools and connected portions in the module.

### CROSS-REFERENCE TO RELATED APPLICATIONS

This application claims priority under 35 U.S.C. § 119 to Korean Patent Application No. 10-2018-0091628, filed on Aug. 7, 2018, and No. 10-2019-0034748, filed on Mar. 27, 2019, in the Korean Intellectual Property Office, the disclosure of which is incorporated herein by reference in its entirety.

### TECHNICAL FIELD

The following disclosure relates to a liquid pump, and more particularly, to a liquid pump included in a module in which a flow path is changed depending on an operation mode.

### BACKGROUND

In general, a vehicle is provided with various systems such as an air conditioning system, a cooling system or the like. These various systems may be roughly distinguished into the air conditioning system including air conditioning modules controlling the air temperature, humidity or the like of a vehicle indoor space when an occupant is in the vehicle, and the cooling system including cooling modules cooling devices such as an engine, a motor or the like to prevent the devices from overheating. These various modules may circulate a heat exchange medium such as a refrigerant, cooling water or the like to transfer heat, and thereby performing desired air conditioning, cooling or the like.

Meanwhile, a conventional engine uses fossil fuel as a driving source of the vehicle. However, a hybrid vehicle using both an engine and an electric motor as the driving source of the vehicle and an electric vehicle using only an electric motor are being gradually developed and more increasingly produced. Conventionally, an amount of heat generated from the motor is smaller than that generated from the engine, and thus a heating system is operated using the amount of heat generated from the engine. However, it is difficult to use such a conventional heating in the electric vehicle and hybrid vehicle. Accordingly, in order to smoothly heat the vehicle, an improved configuration in which the cooling water is heated using a heat pump system or a heater and the air is heated using a heater core is introduced. Meanwhile, when an ambient temperature is too low, such as during winter, a battery of the vehicle may not be operated smoothly. Therefore, a configuration in which battery temperature raising is properly performed may further be required, and this configuration may be combined to the heating system.

As an example, Japanese Patent Laid-Open Publication No. 2012-239344 (“WARM-UP DEVICE OF ELECTRIC VEHICLE”; Dec. 6, 2012) discloses a technique using a system including a plurality of heaters and a heat exchange medium configured to diversely change a flow path to selectively perform heating of a battery or warming a vehicle indoor space, when necessary.

FIGS. 1A and 1B respectively illustrate embodiments of a system for heating and battery temperature raising using a cooling water heater and a heater core. In a heating mode, as illustrated in FIG. 1A, cooling water is pumped and circulated by a cooling water pump 1. First, the cooling water is heated to have a high temperature while passing through a cooling water heater 2; the high temperature cooling water flows into a heater core 3 to be cooled by heat exchange with an external air; and air is heated to be used for heating a vehicle indoor space. The cooling water discharged from the heater core 3 loses heat by the heat exchange with the air and thus has a low temperature, and this low temperature cooling water flows into the cooling water heater 2 again by the cooling water pump 1, such that the cooling water is heated. In this manner, the cooling water circulates in the heating mode.

Meanwhile, when the ambient temperature is too low, such as during winter, a battery 4 may not be smoothly operated and a temperature of the battery 4 may need to be raised. The heating system described above may be used in this case. In a battery temperature raising mode, as illustrated in FIG. 1B, the cooling water discharged from the heater core 3 flows into the battery 4 through a bypass valve 5. Here, even though the cooling water radiates heat from the heater core 3 to have a certain lower temperature, the cooling water still has a temperature higher than the ambient temperature. Therefore, the cooling water radiates the heat to heat the battery 4, such that the temperature of the battery 4 may be raised to an appropriate temperature at which the battery 4 may be smoothly operated. As such, the cooling water passed through the battery 4 is returned to the cooling water pump 1 through a three-way valve 6, and this returned cooling water flows into the cooling water heater 2 by the cooling water pump 1, such that the cooling water is heated. In this manner, the cooling water circulates in the battery temperature raising mode.

Here, in order to change the heating mode and the battery temperature raising mode with each other, opened and closed distribution inlets of the three-way valve 6 may be changed with each other. For example, referring to FIGS. 1A and 1B, in the heating mode, as illustrated in FIG. 1A, the three-way valve 6 may be set to close a distribution inlet toward a battery (i.e. left distribution inlet) and open the remaining distribution inlets; and in the battery temperature raising mode, as illustrated in FIG. 1B, the three-way valve 6 may be set to close a distribution inlet toward the bypass valve (i.e. upper distribution inlet) and open the remaining distribution inlets.

As illustrated in FIGS. 1A and 1B, a module device in which the flow path is changed depending on an operation mode needs a plurality of valves. In order for these valves to be connected to the liquid pump to form the flow path, additional components for assembly such as a hose and a clamp are further needed. However, as the number of components increases, the number of assembling tools increases, the number of additional components for connecting the increased components also increases; and thus the total number of components and assembling tools excessively increases. In addition, an increase in the number of various components to be connected to each other increases the number of connected portions, and cooling water leakage may occur at this connected portion at any time. As a result, a risk of cooling water leakage also increases.

### CITED REFERENCE

### Patent Document

Japanese Patent Laid-Open Publication No. 2012-239344 (“WARM-UP DEVICE OF ELECTRIC VEHICLE”; Dec. 6, 2012)

### SUMMARY

An embodiment of the present disclosure is directed to providing a liquid pump included in a module in which a flow path is changed depending on an operation mode and capable of minimizing the number of components, assembling tools and connected portions in the module by integrally forming a flow path change means and a liquid transfer means with each other.

In addition, an embodiment of the present disclosure is directed to providing a liquid pump capable of reducing a package size by forming an inner flow path which may change a flow of cooling water in the flow path change means and the liquid transfer means which are integrally formed with each other.

In addition, an embodiment of the present disclosure is directed to providing a liquid pump having a simplified assembling structure and a coupling structure preventing both cooling water leakage and assembly loosening, when integrating the flow path change means and the liquid transfer means with each other.

In one general aspect, the liquid pump 100 includes: a liquid transfer means 110 including a body 115 of the liquid transfer means including a liquid pumping means provided therein with an impeller to which a motor is connected, and a plurality of distribution paths respectively formed in a tubular shape and including a first distribution path 111 of the liquid transfer means allowing liquid to flow into and out of the body 115 of the liquid transfer means; and a flow path change means 120 including a body 125 of the flow path change means provided therein with a plurality of opening/closing means, and a plurality of distribution paths respectively formed in a tubular shape and including a first distribution path 121 of the flow path change means allowing liquid to flow into and out of the body 125 of the flow path change means, wherein the liquid transfer means 110 and the flow path change means 120 are integrally formed with each other in such a manner that the first distribution path 111 of the liquid transfer means and the first distribution path 121 of the flow path change means are integrally connected to each other.

Here, in liquid pump 100, when the liquid transfer means 110 and the flow path change means 120 are formed as an integral component, the first distribution path 111 of the liquid transfer means and the first distribution path 121 of the flow path change means may be formed as a single common tube; alternatively, when the liquid transfer means 110 and the flow path change means 120 are formed as separate components, the first distribution path 111 of the liquid transfer means and the first distribution path 121 of the flow path change means may be directly coupled to each other.

In addition, the first distribution path 111 of the liquid transfer means and the first distribution path 121 of the flow path change means may have a shape in which at least one distribution path extends in one direction, or may have a shape in which at least one distribution path is bent at a predetermined angle.

In addition, in the liquid pump 100, an inner diameter of the first distribution path 111 of the liquid transfer means and that of the first distribution path 121 of the flow path change means may be formed to have the same size.

In addition, in the liquid pump 100, a thread portion 111a of the liquid transfer means may be formed on a portion of an outer surface of the first distribution path 111 of the liquid transfer means, a thread portion 121a of the flow path change means may be formed on a portion of an inner surface of the first distribution path 121 of the flow path change means, and the thread portion 111a of the liquid transfer means and the thread portion 121a of the flow path change means may be screw coupled to each other, thereby directly coupling the first distribution path 111 of the liquid transfer means and the first distribution path 121 of the flow path change means to each other.

Alternatively, in the liquid pump 100, a catching portion 111b of the liquid transfer means may be formed protruding from or recessed into a portion of the outer surface of the first distribution path 111 of the liquid transfer means, a catching portion 121b of the flow path change means may be formed protruding from or recessed into a portion of the inner surface of the first distribution path 121 of the flow path change means, and the catching portion 111b of the liquid transfer means and the catching portion 121b of the flow path change means may be hook coupled to each other, thereby directly coupling the first distribution path 111 of the liquid transfer means and the first distribution path 121 of the flow path change means to each other.

Here, in the liquid pump 100, a sealing groove portion 111s of the liquid transfer means may be formed on the outer surface of the first distribution path 111 of the liquid transfer means, and a sealing groove portion 121s of the flow path change means may be formed on an inner surface of the first distribution path 121 of the flow path change means, and when the first distribution path 111 of the liquid transfer means and the first distribution path 121 of the flow path change means are coupled to each other, a sealing member 130 may be provided in an empty space formed at a portion where the sealing groove portion 111s of the liquid transfer means and the sealing groove portion 121s of the flow path change means meet together.

Here, the sealing member 130 may be an O-ring formed of an elastic material.

In addition, the liquid pump 100 may further include a locking structure including a locking protrusion 113 formed on an outer circumference of the liquid transfer means 110, and a locking elastic piece 126 and a locking fixing piece 127, which are respectively formed on one sides of the flow path change means 120.

In addition, the liquid pump 100 may further include a seating member 140 including a seating portion 141 of the liquid transfer means in which the liquid transfer means 110 is seated and secured, a seating portion 142 of the flow path change means in which the flow path change means 120 is seated and secured, and a supporting portion 143 which connects the seating portion 141 of the liquid transfer means and the seating portion 142 of the flow path change means and which is coupled and fixed to an outer structure.

Here, the seating member 140 may include the seating portion 141 of the liquid transfer means, the seating portion 142 of the flow path change means, and the supporting portion 143, which are integrally formed with one another.

In addition, the seating member 140 may include the seating portion 141 of the liquid transfer means, the seating portion 142 of the flow path change means, and the supporting portion 143, which are respectively formed in a plate shape and arranged on the same plane.

In addition, the first distribution path 111 of the liquid transfer means may be formed in two stages to have different inner diameters, and the sealing groove portion 111s of the liquid transfer means may be formed in a stage having a smaller inner diameter D1 and the thread portion 111a of the liquid transfer means may be formed on a stage having a greater inner diameter D2.

In addition, the first distribution path 121 of the flow path change means may be formed to have different outer diameters, and the sealing groove portion 121s of the flow path change means may be formed in a stage having a smaller outer diameter and the thread portion 121a of the flow path change means may be formed on a stage having a greater outer diameter.

In addition, the liquid pump may further include a locking structure preventing a screw coupling between the liquid transfer means and the flow path change means from being released.

Here, the locking structure may include a locking protrusion 113 formed on an outer circumference of the liquid transfer means 110, and a locking elastic piece 126 and a locking fixing piece 127, which are respectively formed on one sides of the flow path change means 120.

In addition, the locking elastic piece 126 may have one end extending from one side of the flow path change means 120, bent at a predetermined angle and then extending in an inclined shape, and may have the other end formed in a free end shape; and the locking fixing piece 127 may extend from one side of the flow path change means 120 while being spaced apart from the free end of the locking elastic piece 126 at a predetermined distance.

In addition, the locking protrusion 113 may be formed by protruding from the outer circumference of the liquid transfer means 110, and may have one end formed in an axial direction and the other end formed in a circumferential direction.

In addition, the flow path change means 120 may further include: a second distribution path 122 of the flow path change means in which the liquid passed through a battery flows; a third distribution path 123 of the flow path change means allowing the liquid from a heater core to flow into the flow path change means 120; and a fourth distribution path 124 of the flow path change means branched in a T shape from the third distribution path 123 of the flow path change means.

In addition, in the liquid pump, a heating mode may be implemented by closing the second distribution path 122 of the flow path change means; and a battery temperature raising mode may be implemented by closing the third distribution path 123 of the flow path change means.

Meanwhile, an air conditioning system may be configured to include the liquid pump and a controller controlling an operation of the liquid pump.

Other features and aspects will be apparent from the following detailed description, the drawings and the claims.

### BRIEF DESCRIPTION OF THE DRAWINGS

FIGS. 1A and 1B respectively illustrate embodiments of a system for heating and battery temperature raising using a cooling water heater and a heater core.

FIG. 2 illustrates an assembled perspective view of a liquid pump according to an embodiment in the present disclosure.

FIG. 3 illustrates an exploded perspective view of a liquid pump according to an embodiment in the present disclosure.

FIG. 4 illustrates an assembled cross-sectional view of a first example of a coupled portion of a liquid pump according to an embodiment in the present disclosure.

FIG. 5 illustrates an exploded cross-sectional view of a first example of a coupled portion of a liquid pump according to an embodiment in the present disclosure.

FIG. 6 illustrates an exploded cross-sectional view of a second example of a coupled portion of a liquid pump according to an embodiment in the present disclosure.

FIG. 7 illustrates an exploded cross-sectional view of a third example of a coupled portion of a liquid pump according to an embodiment in the present disclosure.

FIG. 8 illustrates a partially enlarged perspective view of a locking structure of a liquid pump according to an embodiment in the present disclosure.

FIG. 9 illustrates an assembled perspective view of a liquid pump according to another embodiment in the present disclosure.

FIG. 10 illustrates a view of an inner flow path structure of a liquid pump according to another embodiment in the present disclosure.

FIGS. 11A and 11B illustrate examples of inner flow paths formed in (a) a heating mode and (b) a battery temperature raising mode, respectively, using a liquid pump according to another embodiment of the present disclosure.

### DETAILED DESCRIPTION OF EMBODIMENTS

Hereinafter, a liquid pump according to exemplary embodiments of the present disclosure is described in detail with reference to the accompanying drawings.

### Basic Configuration of the Liquid Pump

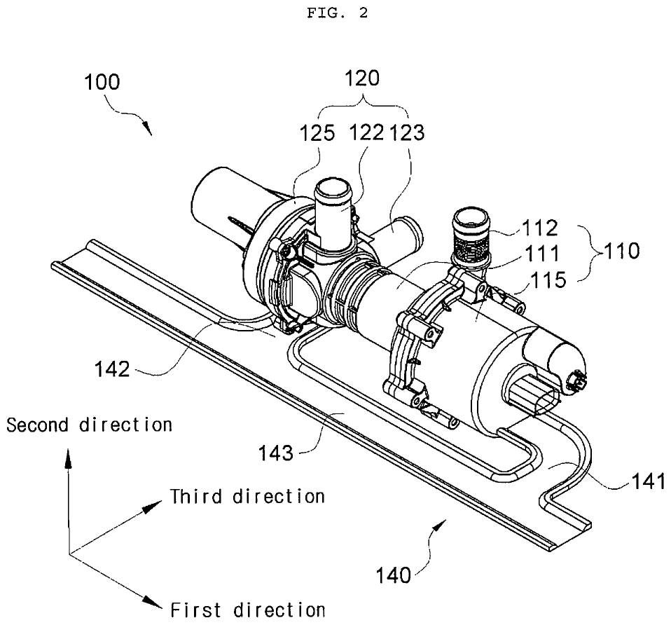

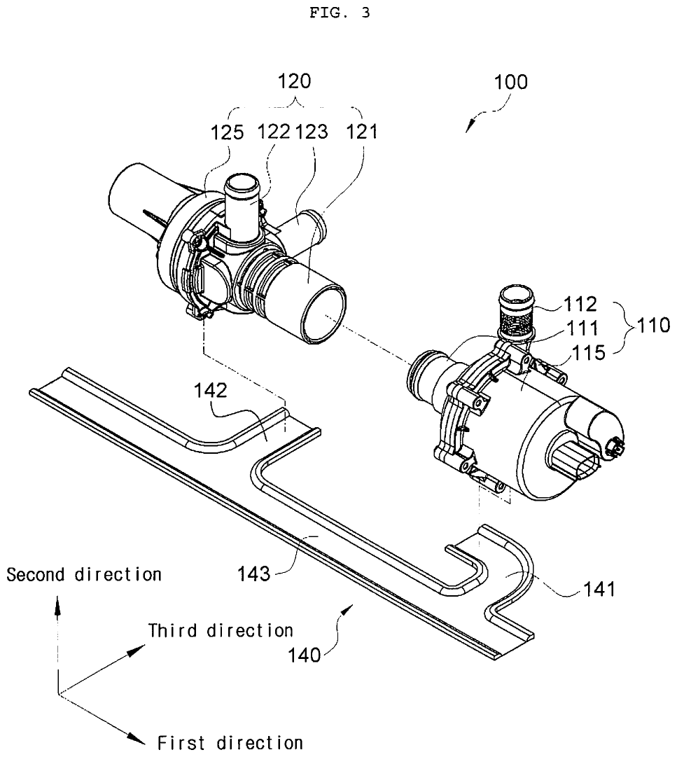

FIG. 2 illustrates an assembled perspective view of a liquid pump according to an embodiment in the present disclosure; and FIG. 3 illustrates an exploded perspective view of a liquid pump according to an embodiment in the present disclosure. As illustrated in FIGS. 2 and 3, a liquid pump 100 according to an embodiment in the present disclosure may include a liquid transfer means 110 and a flow path change means 120, and may further include a seating portion 140.

First, the liquid transfer means 110 may include a body 115 of the liquid transfer means including a liquid pumping means provided therein with an impeller to which a motor is connected, and a plurality of distribution paths respectively formed in a tubular shape and including a first distribution path 111 of the liquid transfer means allowing liquid to be distributed into and out of the body 115 of the liquid transfer means. The liquid transfer means 110 may be implemented as a cooling water pump. In general, the cooling water pump has two distribution paths such as a cooling water inflow path and a cooling water outflow path. FIGS. 2 and 3 illustrate that the liquid transfer means 110 has two distribution paths such as the first distribution path 111 of the liquid transfer means and a second distribution path 112 of the liquid transfer means. However, the present disclosure is not limited thereto. For example, the liquid transfer means 110 may be implemented as a pump having a single inflow path and a plurality of outflow paths. As such, the liquid transfer means 110 may be modified in various ways.

In addition, the flow path change means 120 may include a body 125 of the flow path change means provided therein with a plurality of opening/closing means, and a plurality of distribution paths respectively formed in a tubular shape and including a first distribution path 121 of the flow path change means allowing liquid to be distributed into and out of the body 125 of the flow path change means. The flow path change means 120 may be implemented as a three-way valve, for example; and in this case, the three-way valve has three distribution paths. FIGS. 2 and 3 illustrate that the flow path change means 120 has three distribution paths such as first, second and third distribution paths 121, 122 and 123 of the flow path change means. However, the present disclosure is not limited thereto. For example, the flow path change means 120 is implemented as a four-way valve; and in this case, the four-way valve has four distribution paths. As such, the flow path change means 120 may be modified in various ways.

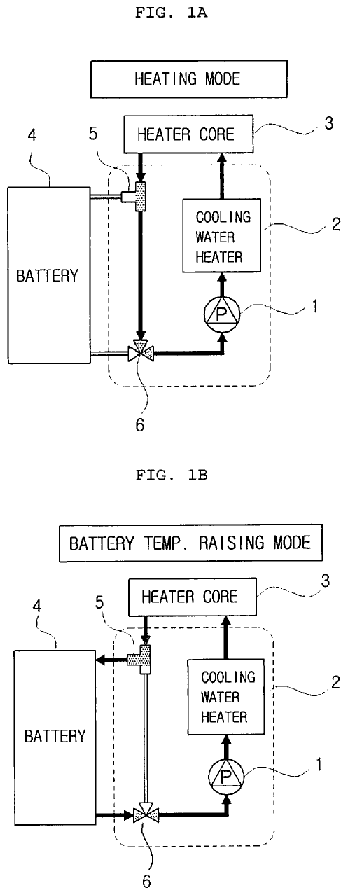

As such, the liquid pump 100 in the present disclosure may be configured to include the liquid transfer means 110 and the flow path change means 120. The liquid transfer means 110 and the flow path change means 120 may be integrally formed with each other in such a manner that the first distribution path 111 of the liquid transfer means and the first distribution path 121 of the flow path change means are integrally connected to each other. As described above, in the present disclosure, the liquid transfer means 110 and the flow path change means 120 may be integrally formed with each other without requiring a separate connecting member such as a clamp and a hose; whereas, referring to FIG. 1, a conventional module capable of changing the flow path is separately provided therein with a cooling water pump 1 and a three-way valve 6. The hose and clamp are required to connect these components to each other, which increases the number of additional components. Also, the number of an assembly process for clamping the hose to a distribution inlet of the cooling water pump 1 or a distribution inlet of the three-way valve 6 increases. When the pump and the valve are connected to each other by a separate connecting member such as the hose, the number of components and assembling tools increases, which causes waste of resources such as manpower, cost and time. In addition, an increase in the number of components to be connected to each other increases connected portions; and cooling water leakage may occur at each of these connected portions, which results in an increased risk of the cooling water leakage throughout the module.

However, as described above, in the present disclosure, the liquid transfer means 110 (corresponding to the cooling water pump 1 in embodiments of FIGS. 1A and 1B) and the flow path change means 120 (corresponding to the three-way valve 6 in embodiments of FIGS. 1A and 1B) are directly coupled to each other, such that there is no need for any additional components such as the hose and the clamp. Accordingly, the number of components and assembling tools may naturally be reduced, thereby saving resources such as manpower, cost and time. In addition, by integrating and minimizing the connected portions into a single direct-coupled portion, the risk of the cooling water leakage may further be reduced as compared to the conventional module.

In other words, the liquid pump 100 in the present disclosure is characterized in that the liquid transfer means 110 and the flow path change means 120 are integrally formed with each other. In the present disclosure, the first distribution path 111 of the liquid transfer means and the first distribution path 121 of the flow path change means may refer to the distribution paths connected to each other to integrally form the liquid transfer means and the flow path change means with each other. FIGS. 2 and 3 illustrate that in the liquid transfer means 110, the first distribution path 111 of the liquid transfer means extends in a first direction, and the second distribution path 112 of the liquid transfer means extends in a second direction. Also, it is illustrated that in the flow path change means 120, the first distribution path 121 of the flow path change means extends in the first direction, the second distribution path 122 of the flow path change means extends in the second direction and the third distribution path 123 of the flow path change means extends in a third direction. However, this embodiment is only an example; and the present disclosure is not limited thereto. For example, in the liquid transfer means 110, the distribution paths 111 and 112 may all extend in the first direction and may be formed on one side or the other side of the body 115 of the liquid transfer means. As such, the liquid transfer means 110 may be modified in various ways. In other words, the number, an extension direction, a shape or the like of the distribution paths formed in the liquid pump 100 of the present disclosure are not limited to those illustrated in FIGS. 2 and 3 and may be variously changed when necessary. However, only the distribution paths, which are connected to each other to integrally form the liquid transfer means 110 and the flow path change means 120 with each other, may be specially referred to as “the first distribution path 111 of the liquid transfer means” and “the first distribution path 121 of the flow path change means.”

Meanwhile, the liquid transfer means 110 and the flow path change means 120 may be a complete integral component in a manufacturing stage; alternatively, may be formed of separate components, and may be integrated by being coupled to each other. The liquid transfer means 110 and the flow path change means 120 may generally be formed of an injection-molded material such as plastic. Therefore, even though the liquid transfer means 110 and the flow path change means 120 have somewhat complicated shapes, these means may be easily manufactured as an integral component or separate components.

When the liquid transfer means 110 and the flow path change means 120 are formed as an integral component, the first distribution path 111 of the liquid transfer means and the first distribution path 121 of the flow path change means may be formed as a single common tube. The liquid transfer means 110 may embed a liquid pumping means (pump) therein; and the flow path change means 120 may generally be implemented as a valve. The liquid transfer means 110 and the flow path change means 120 may unavoidably be spaced apart from each other at a predetermined distance not to interfere with each other. In order for the liquid transfer means 110 and the flow path change means 120 to be separated from each other at a predetermined distance and to be integrally formed with each other, the body 115 of the liquid transfer means and the body 125 of the flow path change means may be formed as a single housing connected by a single tube. Here, the ‘single tube’ connecting the body 115 of the liquid transfer means and the body 125 of the flow path change means to each other may correspond to the first distribution path 111 of the liquid transfer means included in the liquid transfer means 110 and may correspond to the first distribution path 121 of the flow path change means included in the flow path change means 120. As described above, “The first distribution path 111 of the liquid transfer means and the first distribution path 121 of the flow path change means are formed as a single common tube” may refer to this configuration.

When the liquid transfer means 110 and the flow path change means 120 are formed as separate components, the first distribution path 111 of the liquid transfer means and the first distribution path 121 of the flow path change means, which are respectively formed in the two means, may be directly coupled to each other. Here, each of the distribution paths may be naturally formed as a separate component. However, the distribution paths may be directly coupled to each other and accordingly, the distribution paths may be coupled to each other without any additional need for separate connecting components. For example, in the liquid pump 100, as illustrated in FIGS. 2 and 3, the first distribution path 111 of the liquid transfer means and the first distribution path 121 of the flow path change means may be positioned on the same axis to be directly coupled to each other. In this case (in which the distribution paths is coupled to each other), as illustrated in FIGS. 2 and 3, it is preferable that an inner diameter of the first distribution path 111 of the liquid transfer means and that of the first distribution path 121 of the flow path change means are formed to have the same size, thereby preventing a sudden change in the size of the diameter of the distribution path, by which the liquid flows, to reduce unnecessary adverse effects such as a pressure drop.

In addition, FIGS. 2 and 3 illustrate that both the first distribution path 111 of the liquid transfer means and the first distribution path 121 of the flow path change means extend in a single direction and the distribution paths are connected to each other in a straight line. However, the present disclosure is not limited thereto. The first distribution path 111 of the liquid transfer means and the first distribution path 121 of the flow path change means may be modified to have a shape appropriately bent depending on positions of the bodies themselves of the liquid transfer means 110 and the flow path change means 120, a position where the distribution path is formed on each body and the like. In detail, the first distribution path 111 of the liquid transfer means and the first distribution path 121 of the flow path change means may have a shape in which at least one distribution path extends in one direction, or have a shape in which at least one distribution path is bent at a predetermined angle. For example, as illustrated in FIGS. 2 and 3, both distribution paths may extend in one direction to form a straight connection, or one of the distribution paths may extend in one direction and the other of the distribution paths may be bent in a right angle to form a right angle connection between each other. Alternatively, both distribution paths may be bent at right angles to form a U-shaped connection between each other, and for example, the bending angle may be 120 degrees, such that both distribution paths may form a flexible obtuse angle connection between each other. The connection of the two distribution paths may be modified in various ways.

### Various Examples of the Coupled Portions of the Liquid Pump

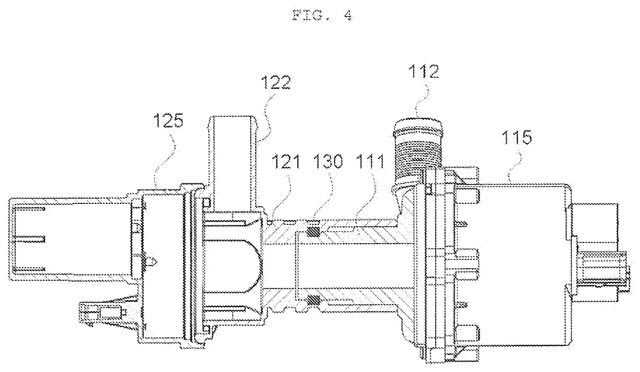

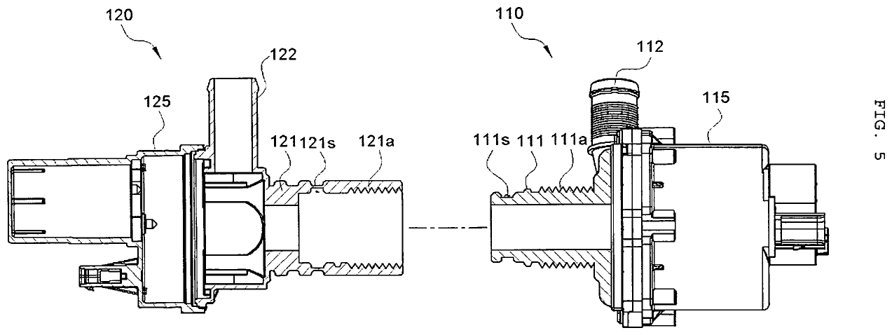

FIG. 4 illustrates an assembled cross-sectional view of a first example of a coupled portion of a liquid pump according to an embodiment in the present disclosure; and FIG. 5 illustrates an exploded cross-sectional view of a first example of a coupled portion of a liquid pump according to an embodiment in the present disclosure.

As illustrated in the exploded cross-sectional view of FIG. 5, in the first example of the coupled portion of the liquid pump, a thread portion 111a of the liquid transfer means may be formed on a portion of an outer surface of the first distribution path 111 of the liquid transfer means, and a thread portion 121a of the flow path change means may be formed on a portion of an inner surface of the first distribution path 121 of the flow path change means. The thread portion 111a of the liquid transfer means and the thread portion 121a of the flow path change means, as thus formed, may be screw coupled to each other as illustrated in the assembled cross-sectional view of FIG. 4. In this manner, the first distribution path 111 of the liquid transfer means and the first distribution path 121 of the flow path change means are directly coupled to each other.

In order to reduce the risk of liquid leakage at such a coupled portion, the liquid pump 100 in the present disclosure may further include a sealing member 130. Here, in the liquid pump 100, a sealing groove portion 111s of the liquid transfer means may be formed on the outer surface of the first distribution path 111 of the liquid transfer means, and a sealing groove portion 121s of the flow path change means may be formed on an inner surface of the first distribution path 121 of the flow path change means. When the first distribution path 111 of the liquid transfer means and the first distribution path 121 of the flow path change means are coupled to each other, an empty space may be formed at a portion where the sealing groove portion 111s of the liquid transfer means and the sealing groove portion 121s of the flow path change means meet together. The sealing member 130 may be provided in the space thus formed to significantly reduce the risk of the liquid leakage at the coupled portion. The sealing member 130 may be, for example, an 0-ring formed of an elastic material. In addition, since the sealing member 130 is formed of such an elastic material, the sealing member 130 may serve as a vibration attenuation function, that is, may serve to attenuate vibration generated in and transmitted from the liquid transfer means 110 to the flow path change means 120.

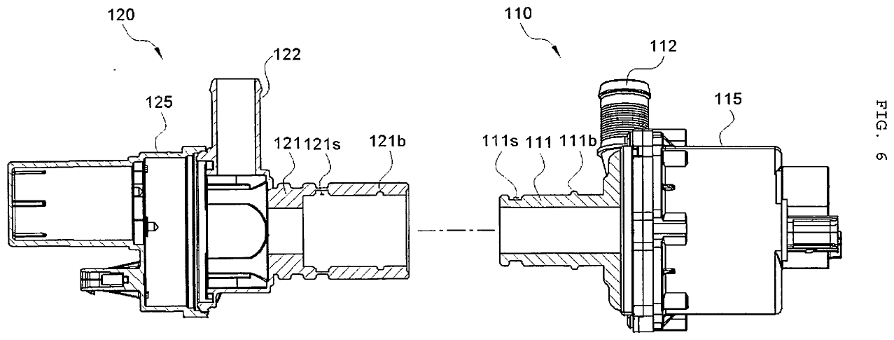

FIG. 6 illustrates an exploded cross-sectional view of a second example of a coupled portion of a liquid pump according to an embodiment in the present disclosure.

As illustrated in the exploded cross-sectional view of FIG. 6, in the second example of the coupled portion of the liquid pump, a catching portion 111b of the liquid transfer means may be formed protruding from or recessed into a portion of the outer surface of the first distribution path 111 of the liquid transfer means, and a catching portion 121b of the flow path change means may be formed protruding from or recessed into a portion of the inner surface of the first distribution path 121 of the flow path change means. The catching portion 111b of the liquid transfer means and the catching portion 121b of the flow path change means, as thus formed, may be hook coupled to each other as illustrated in the assembled cross-sectional view of FIG. 4, thereby directly coupling the first distribution path 111 of the liquid transfer means and the first distribution path 121 of the flow path change means to each other.

In the second example of the coupled portion of the liquid pump, the sealing member 130 may also be provided to reduce the risk of the liquid leakage.

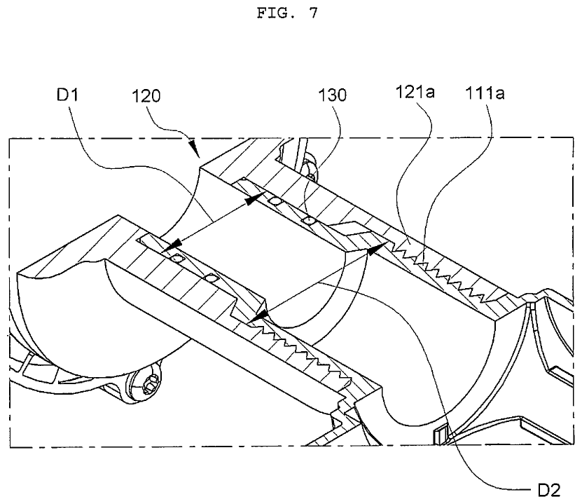

FIG. 7 illustrates an exploded cross-sectional view of a third example of a coupled portion of a liquid pump according to an embodiment in the present disclosure.

In the third example of the coupled portion of the liquid pump according to an embodiment in the present disclosure, both the thread portion 111a of the liquid transfer means and the sealing groove portion 111s of the liquid transfer means may be formed on the first distribution path 111 of the liquid transfer means. Here, the first distribution path 111 of the liquid transfer means may be formed in two stages to have different inner diameters. The sealing groove portion 111s of the liquid transfer means may be formed in a stage having a smaller inner diameter D1; and the thread portion 111a of the liquid transfer means may be formed on a stage having a greater inner diameter D2. Correspondingly, the first distribution path 121 of the flow path change means may be also formed to have different outer diameters. The sealing groove portion of the flow path change means may be formed in a stage having a smaller outer diameter and the thread portion 121a of the flow path change means may be formed on a stage having a greater outer diameter.

Through this configuration, the sealing member 130 may first be provided in the sealing groove portion 121s of the flow path change means; an end of the sealing groove portion 121s of the flow path change means may be positioned at the stage having the smaller inner diameter of the first distribution path 111 of the liquid transfer means. Thereafter, when the first distribution path 121 of the flow path change means rotates, the first distribution path 121 of the flow path change means rotates forward along the thread, and the sealing member 130 advances together to be seated in the sealing groove portion 111s of the liquid transfer means, thereby coupling and sealing the first distribution path 111 of the liquid transfer means and the first distribution path 121 of the flow path change means to each other.

Here, the liquid pump in the present disclosure may further include a locking structure preventing a rotational coupling between the liquid transfer means 110 and the flow path change means 120 from being released.

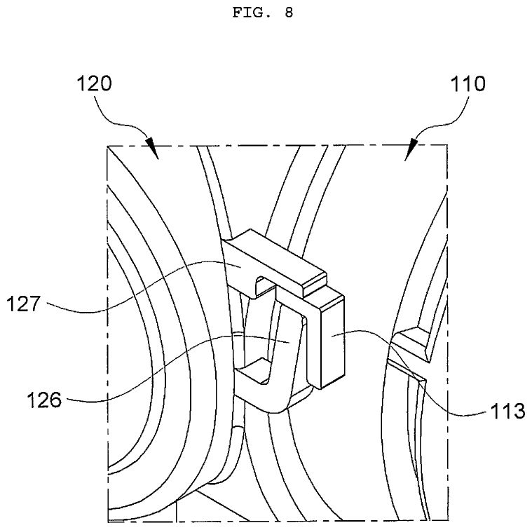

FIG. 8 illustrates a partially enlarged perspective view of a locking structure of a liquid pump according to an embodiment in the present disclosure. Referring to FIG. 8, the locking structure in the present disclosure may include a locking protrusion 113 formed on the outer circumference of the liquid transfer means 110, and a locking elastic piece 126 and a locking fixing piece 127, which are respectively formed on one sides of the flow path change means 120. In more detail, the locking protrusion 113 in the present disclosure may be formed by protruding from the outer circumference of the liquid transfer means 110, and may have one end formed in an axial direction and the other end formed in a circumferential direction to have a substantial ‘upside down L’ shape. The locking elastic piece 126 in the present disclosure may have one end extending from one side of the flow path change means 120 and bent at a predetermined angle and then extending in an inclined shape, and have the other end formed in a free end shape. Here, the one end may be fixed and the other end may not be fixed, and through this configuration, the locking elastic piece 126 may have a certain elasticity. Meanwhile, the locking fixing piece 127 in the present disclosure may extend from one side of the flow path change means 120 while being spaced apart from the free end of the locking elastic piece 126 at a predetermined distance.

Referring to the embodiments as described above, the locking structure for preventing a screw coupling of the liquid transfer means 110 and the flow path change means 120 from being released is described in detail. First, when the first distribution path 121 of the flow path change means may rotate forward along the thread, the one end of the locking protrusion 113 extending in the axial direction may contact an outer surface of the bent portion of the locking elastic piece 126. As the first distribution path 121 of the flow path change means continuously rotates, elasticity may be given to the locking elastic piece 126. After the first distribution path 121 of the flow path change means rotates at a predetermined angle and the one end of the locking protrusion 113 passes through the free end of the locking elastic piece 126, the one end of the locking protrusion 113 may be inserted into a gap between the free end of the locking elastic piece 126 and the locking fixing piece 127. Here, the locking protrusion 113 may not rotate any longer due to the locking fixing piece 127. In this manner, the liquid transfer means 110 and the flow path change means 120 may be locked to each other, thereby preventing the rotational coupling therebetween from being released.

### Additional Configuration of the Liquid Pump

As described above, the liquid pump 100 according to an embodiment in the present disclosure is a device in which a pump and a valve are integrally formed with each other. In this case, the pump and the valve may be housed as an integral component itself or as separate components which are directly coupled to and integrated with each other. However, it is preferable that the liquid pump 100 further includes a seating member 140 to more securely fix a coupling between the pump the valve and to easily connect a pump-valve integral assembly to an outer structure.

As illustrated in FIGS. 2 and 3, the seating member 140 may include a seating portion 141 of the liquid transfer means in which the liquid transfer means 110 is seated and secured, a seating portion 142 of the flow path change means in which the flow path change means 120 is seated and secured, and a supporting portion 143 which connects the seating portion 141 of the liquid transfer means and the seating portion 142 of the flow path change means and which is coupled and fixed to an outer structure. In this case, it is preferable that the seating member 140 includes the seating portion 141 of the liquid transfer means, the seating portion 142 of the flow path change means, and the supporting portion 143, which are integrally formed with one another. In this manner, the pump-valve integral assembly may have further improved support stability and a coupling force.

As illustrated in FIGS. 2 and 3, when the seating member 140 includes respective portions integrally formed with each other, it is preferable that the seating portion 141 of the liquid transfer means, the seating portion 142 of the flow path change means and the supporting portion 143 are respectively formed in a plate shape and arranged on the same plane. In this manner, it may be significantly easy to manufacture the seating member 140, to assemble the pump-valve integral assembly and the seating member 140 to each other and to assemble the liquid pump 100 (including the seating member 140) and the outer structure to each other.

Meanwhile, the liquid transfer means 110 may include a liquid pumping means provided therein with an impeller to which a motor is connected, and may further include additional components such as a connector supplying electric power to the motor and a motor receiving portion embedding the motor therein. In addition, the liquid transfer means 110 may further include a cooling pin to avoid an adverse effect that heat is generated due to rotation of the motor and thus unnecessary heating occurs in the liquid (for example, the cooling water) pumped by the liquid pump 100.

Here, as a spaced distance between the liquid transfer means 110 and the flow path change means 120 is minimized, a length of the flow path therebetween is shortened, such that adverse effects such as a pressure drop is minimized. Accordingly, it is preferable that the additional components such as the connector, the motor receiving portion and the cooling fin, as described above, are positioned in a region other than a region where the liquid transfer means 110 and the flow path change means 120 are connected to each other.

### Another Embodiment of the Liquid Pump

According to another embodiment in the present disclosure, the flow path change means 120 may include a four-way valve including four distribution paths.

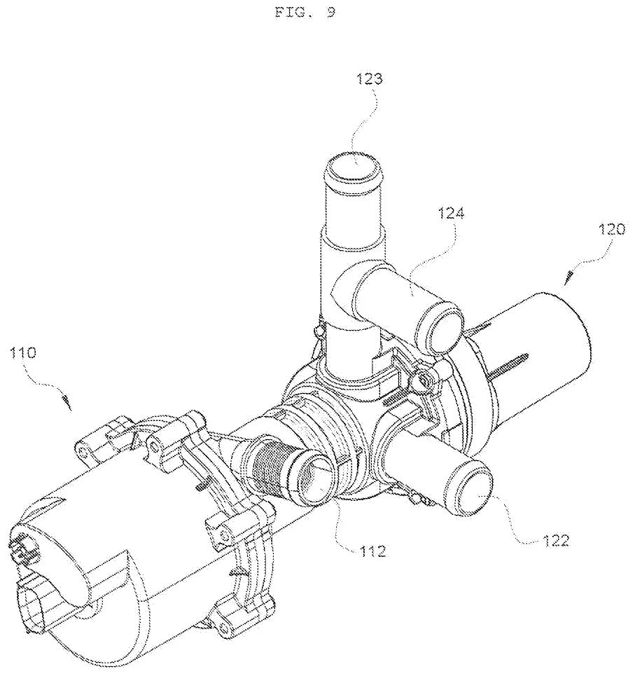

FIG. 9 illustrates an assembled perspective view of a liquid pump including four distribution paths according to another embodiment in the present disclosure. Referring to FIG. 9, the flow path change means 120 according to another embodiment in the present disclosure may include a fourth distribution path 124 of the flow path change means branched in a T shape from the third distribution path 123 of the flow path change means. As such, when another distribution path is added to the flow path change means 120, an inner flow path may be formed in such a manner that the cooling water flows first into the flow path change means 120 and then flows into the liquid transfer means 110. In addition, a flow path for outer circulation may be removed, such that a package size may be further reduced, and cost and weight may also be further reduced.

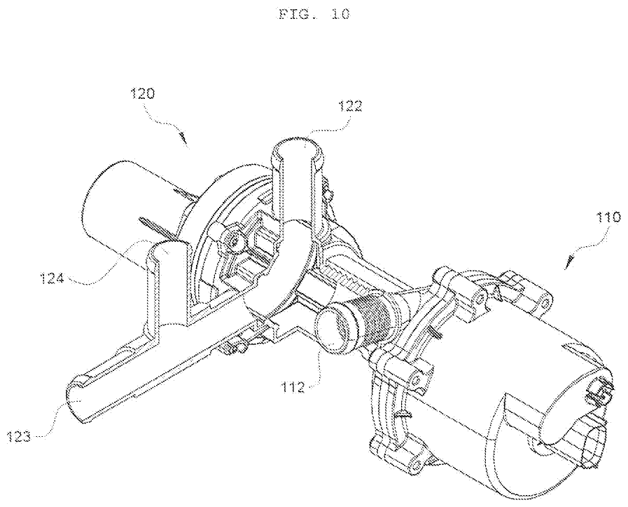

FIG. 10 is a view explaining an inner flow path structure of a liquid pump including a fourth distribution path 124 of the flow path change means according to another embodiment in the present disclosure. Referring to FIG. 10, the first distribution path of the flow path change means 120 and the first distribution path of the liquid transfer means 110 may be combined to form an integral body; and the second, third and fourth distribution paths 122, 123 and 124 of the flow path change means may be formed in an outer circumferential direction of the flow path change means 120. Here, by closing some of the distribution paths in the flow path change means 120, a heating mode and a battery temperature raising mode may be changed with each other in the liquid pump 100.

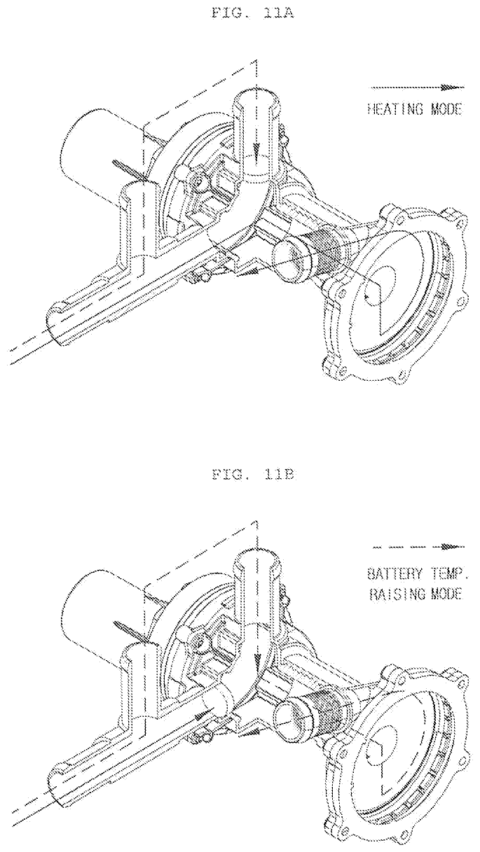

FIGS. 11A and 11B illustrate examples of forming a heating mode and a battery temperature raising mode, respectively, using a liquid pump according to another embodiment of the present disclosure. Referring to FIG. 11A, by closing the second distribution path 122 of the flow path change means into which the cooling water passed through a battery flows, the cooling water does not flow toward the battery but directly flows into the liquid transfer means 110 to be discharged, thereby forming a flow path in which the cooling water passes through a cooling water heater and a heater core. In this manner, the heating mode heating a vehicle indoor may be implemented. Meanwhile, referring to FIG. 11B, by closing between the third distribution path 123 of the flow path change means through which the cooling water flows and the first distribution path 121 of the flow path change means through which the cooling water is discharged to the liquid transfer means 110, the cooling water may flow toward the battery through the fourth distribution path 124 of the flow path change means, thereby forming a flow path in which the cooling water performing the battery temperature raising passes through the cooling water heater and the heater core. In this manner, the battery temperature raising mode performing the battery temperature raising may be implemented.

As such, in the present disclosure, the inner flow path capable of changing the flow of the cooling water may be formed in the flow path change means and the liquid transfer means which are integrally formed with each other, and thereby reducing the package size.

According to the present disclosure, the liquid pump included in the module in which a flow path is changed depending on an operation mode may minimize the number of components, assembling tools and connected portions in the module by integrally forming the flow path change means and the liquid transfer means with each other.

In addition, the liquid pump may reduce the package size by forming the inner flow path capable of changing the flow of the cooling water in the flow path change means and the liquid transfer means which are integrally formed with each other.

In addition, the liquid pump may have a simplified assembling structure and may prevent both the cooling water leakage and the assembly loosening, when integrating the flow path change means and the liquid transfer means with each other.

As such, the number of components and assembling tools may be reduced, thereby saving resources such as manpower, cost and time for manufacturing and assembling the liquid pump. In addition, by minimizing the connected portions in the module, the risk of the cooling water leakage in the module may further be reduced as compared to the conventional module.

Although the present disclosure is shown and described with respect to specific embodiments, it is apparent to those having ordinary skill in the art that the present disclosure may be variously modified and altered without departing from the spirit and scope of the present disclosure as defined by the following claims.

What is claimed is:

1. A liquid pump comprising:
a liquid transfer means including a body of the liquid transfer means including a liquid pumping means provided therein with an impeller to which a motor is connected, and a plurality of distribution paths respectively formed in a tubular shape and including a first distribution path of the liquid transfer means allowing liquid to flow into and out of the body of the liquid transfer means; and
a flow path change means including a body of the flow path change means provided therein with a plurality of opening/closing means, and a plurality of distribution paths respectively formed in a tubular shape and including a first distribution path of the flow path change means allowing liquid to flow into and out of the body of the flow path change means,
wherein the liquid transfer means and the flow path change means are integrally formed with each other in such a manner that the first distribution path of the liquid transfer means and the first distribution path of the flow path change means are integrally connected to each other.

2. The liquid pump of claim 1,
wherein when the liquid transfer means 110 and the flow path change means 120 are formed as an integral component, the first distribution path 111 of the liquid transfer means and the first distribution path 121 of the flow path change means are formed as a single common tube; alternatively,
when the liquid transfer means 110 and the flow path change means 120 are formed as separate components, the first distribution path 111 of the liquid transfer means and the first distribution path 121 of the flow path change means are directly coupled to each other.

3. The liquid pump of claim 1,
wherein the first distribution path of the liquid transfer means and the first distribution path of the flow path change means have a shape in which at least one distribution path extends in one direction, or
have a shape in which at least one distribution path is bent at a predetermined angle.

4. The liquid pump of claim 1, wherein an inner diameter of the first distribution path of the liquid transfer means and that of the first distribution path of the flow path change means are formed to have the same size.

5. The liquid pump of claim 1,
wherein a thread portion of the liquid transfer means is formed on a portion of an outer surface of the first distribution path of the liquid transfer means, a thread portion of the flow path change means is formed on a portion of an inner surface of the first distribution path of the flow path change means, and the thread portion of the liquid transfer means and the thread portion of the flow path change means are screw coupled to each other; alternatively
a catching portion of the liquid transfer means is formed protruding from or recessed into a portion of the outer surface of the first distribution path of the liquid transfer means, a catching portion of the flow path change means is formed protruding from or recessed into a portion of the inner surface of the first distribution path of the flow path change means, and the catching portion of the liquid transfer means and the catching portion of the flow path change means are hook coupled to each other,
thereby directly coupling the first distribution path of the liquid transfer means and the first distribution path of the flow path change means to each other.

6. The liquid pump of claim 5,
wherein a sealing groove portion of the liquid transfer means is formed on the outer surface of the first distribution path of the liquid transfer means, and a sealing groove portion of the flow path change means is formed on an inner surface of the first distribution path of the flow path change means, and
when the first distribution path of the liquid transfer means and the first distribution path of the flow path change means are coupled to each other, a sealing member is provided in an empty space formed at a portion where the sealing groove portion of the liquid transfer means and the sealing groove portion of the flow path change means meet together.

7. The liquid pump of claim 6, wherein the sealing member is an O-ring formed of an elastic material.

8. The liquid pump of claim 5, further comprising a locking structure including a locking protrusion formed on an outer circumference of the liquid transfer means, and a locking elastic piece and a locking fixing piece, which are respectively formed on one sides of the flow path change means.

9. The liquid pump of claim 1, further comprising a seating member including a seating portion of the liquid transfer means in which the liquid transfer means is seated and secured, a seating portion of the flow path change means in which the flow path change means is seated and secured, and a supporting portion which connects the seating portion of the liquid transfer means and the seating portion of the flow path change means and which is coupled and fixed to an outer structure.

10. The liquid pump of claim 9, wherein the seating member includes the seating portion of the liquid transfer means, the seating portion of the flow path change means, and the supporting portion, which are integrally formed with one another.

11. The liquid pump of claim 9, wherein the seating member includes the seating portion of the liquid transfer means, the seating portion of the flow path change means, and the supporting portion, which are respectively formed in a plate shape and arranged on the same plane.

12. The liquid pump of claim 5, wherein the first distribution path of the liquid transfer means is formed in two stages to have different inner diameters, and the sealing groove portion of the liquid transfer means is formed in a stage having a smaller inner diameter and the thread portion of the liquid transfer means is formed on a stage having a greater inner diameter.

13. The liquid pump of claim 7, wherein the first distribution path of the flow path change means is formed to have different outer diameters, and the sealing groove portion of the flow path change means is formed in a stage having a smaller outer diameter and the thread portion of the flow path change means is formed on a stage having a greater outer diameter.

14. The liquid pump of claim 12, further comprising a locking structure preventing a screw coupling between the liquid transfer means and the flow path change means from being released.

15. The liquid pump of claim 14, wherein the locking structure includes a locking protrusion formed on an outer circumference of the liquid transfer means, and a locking elastic piece and a locking fixing piece, which are respectively formed on one sides of the flow path change means.

16. The liquid pump of claim 15,
wherein the locking elastic piece has one end extending from one side of the flow path change means, bent at a predetermined angle and then extending in an inclined shape, and has the other end formed in a free end shape; and
the locking fixing piece extends from one side of the flow path change means while being spaced apart from the free end of the locking elastic piece at a predetermined distance.

17. The liquid pump of claim 16, wherein the locking protrusion is formed by protruding from the outer circumference of the liquid transfer means, and has one end formed in an axial direction and the other end formed in a circumferential direction.

18. The liquid pump of claim 2,
wherein the flow path change means further includes:
a second distribution path of the flow path change means in which the liquid passed through a battery flows;
a third distribution path of the flow path change means allowing the liquid from a heater core to flow into the flow path change means; and
a fourth distribution path of the flow path change means branched in a T shape from the third distribution path of the flow path change means.

19. The liquid pump of claim 18,
wherein a heating mode is implemented by closing the second distribution path of the flow path change means; and
a battery temperature raising mode is implemented by closing the third distribution path of the flow path change means.

20. An air conditioning system comprising the liquid pump of claim 1 and a controller controlling an operation of the liquid pump.
